(19) United States
(12) Patent Application Publication
(10) Pub. No.: US 2007/0150402 A1
(43) Pub. Date: Jun. 28, 2007

(54) Variable price auction

(76) Inventors: Robert Longman, Chicago, IL (US); Sophia C. Li, Chicago, IL (US)

Correspondence Address: Smart Auctions, Inc.;Attn : Robert Longman & Sophia C. Li, 1749 Golf Rd. #145, Mt. Prospect, IL, 60056, US

(21) Appl. No.: 11/320,133

(22) Filed: Dec. 28, 2005

(51) Int. Cl. G06Q 40/00

(52) U.S. Cl. 705/37

(57) ABSTRACT

The present invention provides a method and system for conducting an open online auction. The seller will provide both a minimum price to which he/she is willing to sell an item and a desired price that is higher than the minimum price. The minimum price and desired price set by the seller are unknown to potential buyers. During the auction duration, the price of an item will fluctuate between the minimum price and desired price set by the seller. Potential buyers have the option to purchase an item under the present invention at any time during the auction period and end the auction upon his/her purchase, however, the price at which potential buyers is willing to purchase varies from one bidder to another. If no buyer is willing to purchase the item at the price range between seller's minimum price and desired price during the auction period, the auction will end with no winner. The auction has a scheduled deadline provided by the auction system provider and selected by the seller of the item.

### FIELD OF INVENTION

The invention relates to auctions and more particularly to online auctions for goods and services.

### BACKGROUND

Fixed price auction has experience remarkable success in online environment. It stresses on efficiency of auction transactions when both sellers and buyers are willing to end auctions at the same price. The problem, however, is that potential buyers often wait for a fixed price auction to end without bid in order to hope for a price reduction when seller re-list the item. Buyer's waiting game is surprisingly effective. At any fixed price listing, there could be a dozen of watchers, yet no buyer is willing to end the auction through an instant purchase, not because the price of an item fails to match price in buyers' mind; rather, buyers are waiting for price cut from the seller regardless how reasonable the initial fixed price is. Many fixed priced auctions went through multiple re-listings with multiple price cuts prior to successful sales. This puts sellers in a disadvantage, and true market prices are defeated by buyers' strategic uniformity in delaying consumption for lower pricings. Although in common marketplaces delaying consumption is usually caused by buyers belief that prices of items are expected to decline further, delaying purchases in online auctions are not affected by buyers' expectation of the prices on items. Instead, it is simply a strategy to frustrate sellers in order to compel price reductions. The issue is how an auction should be designed so that buyers in the auction will be more reluctant to practice waiting games to place pressure on seller for price cuts. The current invention is invented with this issue in mind and will effectively deter buyers from engaging waiting game.

### SUMMARY OF THE INVENTION

The present invention provides a superior archetype for conducting online auctions. The seller will provide both a minimum price to which he/she is willing to sell an item and a desired price that is higher than the minimum price. The minimum price and desired price set by the seller are unknown to potential buyers. During the auction duration, the price of an item will fluctuate between the minimum price and desired price set by the seller. Potential buyers have the option to purchase an item under the present invention at any time during the auction period and end the auction upon his/her purchase, however, the price at which potential buyers is willing to purchase varies from one bidder to another. If no buyer is willing to purchase the item at the price range between seller's minimum price and desired price during the auction period, the auction will end with no winner. The auction has a scheduled deadline provided by the auction system provider and selected by the seller of the item.

### BREIF DESCRIPTION OF THE DRAWINGS

FIG. 1 is an overall diagram of the system.

FIG.2 illustrates the elements on a web page for conducting a Variable Price Auction.

### DESCRIPTION OF PREFERRED EMBODIMENTS

As used herein the following terms have the meaning given below:

“Item”—means goods and services, rights or properties.

“Auction Duration”—means the period between the auction start date and scheduled end date.

“User ID”—means the identification a buyer or seller use during the auction process.

“Minimum Price”—is the lowest price a seller is willing to sell an item.

“Desired Price”—is the preferred price a seller would like to obtain for an item. (Although sellers are always looking for unrestricted higher price on an item, the fact is that unreasonable desired price will not result sales and is actually counter-productive).

“Expected Price”—is the fair price formulated in potential buyer's mind about the value of a listed item. Expected Price can vary from the same potential buyer during auction duration.

“End Variable Price”—means a particular variable price at a particular time within the auction duration that a potential buyer is able to accept the particular price and ends the auction.

“System Controller”—means a computer system or web server that performs various calculations and operations hereinafter described.

“System Operator”—means an individual, company, party, entrepreneur or other entity that operates or is responsible for the computer system or web server that performs various calculations and operations hereinafter described. This entity will act as the liaison between sellers and buyers for conducting an online Variable Price auction.

“Potential Buyer”—means anyone within the system network who has learned of a Variable Price auction, has shown interests in participating in the auction, and may participate in the auction during the course of the auction.

### DETAILED DESCRIPTION OF THE INVENTION

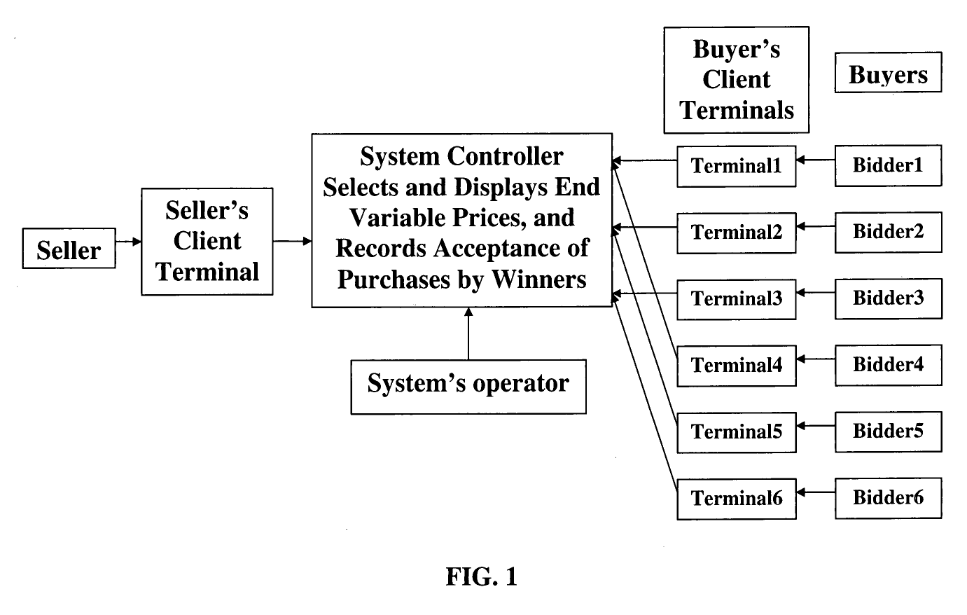

An overall diagram of the invention is shown in FIG. 1. For each variable price auction, the system connects the single seller with plurality of buyers by means of a system controller. There can only be one seller for each listing auction; however, the actual numbers of potential buyers for each auction can be greater or less than six. The system controller can handle almost unrestricted amount of auction listings; at any time, there are plurality of sellers, plurality of buyers, and plurality of auctions within the system network.

The seller communicates with the controller via the seller's client terminal, and the buyers 1 to 6 communicate with the controller via buyer's client terminals 1 to 6. Communication is via the Internet. Both the seller and the buyers' terminals are connected to an ISP (Internet Service Provider) which provides access to the Internet. Correspondingly, controller is also connected to the Internet via an ISP. The drawing lines in FIG. 1 thus represent logical information flow and not physical connections. The seller and the buyers 1 to 6 are described as being online.

The seller's client terminal can be a variety of forms of terminals that are obtainable such as computers, laptops, WebTVs, PDAs, information appliances, or any other devices that can be used by the seller to access the system controller over a network, so the seller can specify description and terms of the item being auctioned, answer questions and requests from potential buyers.

The system controller is one or more network servers running software to keep track the seller's description and auction terms; “intelligently” manage appearance of the auction listing on one or more virtual media such as web sites; select and display variable prices in accordance to a seller's minimum price and desired price, and correctly track or process acceptance of End Variable Price by buyers.

The system operator utilizes a client terminal to access and configure the system's controller as is conventional with computer systems and network servers.

The buyers' client terminal 1 to 6 are any of the various forms of terminals that are employed to access web sites such as computers, laptops, thin-client, WebTVs, two-way TV, PDAs, information appliances, or any other devices that buyers may utilize to learn auction listings presented by the controller, post questions or request regarding the auction listing, and be able to accept End Variable Price using buyers' client terminals.

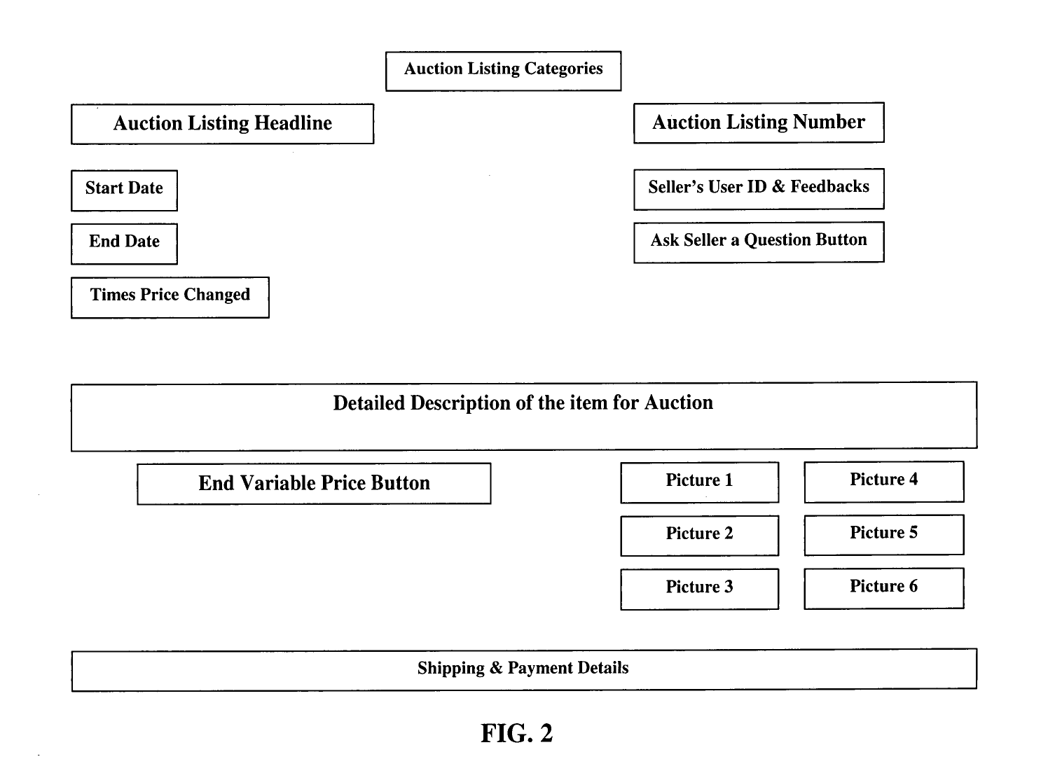

FIG. 2 is a diagram illustrating the elements on a web page which the controller presents to potential buyers 1 to 6. It is noted that FIG. 2 merely illustrates the fields that are relevant to a preferred embodiment of the invention. FIG. 2 is not meant to illustrate the actual layout of a web page. An actual web page would be laid out in a creative, artistic fashion so as to present a pleasing visual appearance. The artistic nature of the visual appearance of the web page is not relevant to the present invention.
a) A conventional “auction listing categories” is a brief reference of the nature of the item being auctioned. It is relevant to the system's categorization function, but such field is not required for the purpose of system operation.
b) A conventional “auction listing headline” may include a brief description of the item being auctioned. It is relevant to the system's search function which is commonly used by buyers, but such field is not actually essential to the operation of the system.
c) A conventional “auction listing number” is a series of computer generated numbers which is implemented by the system controller for identification purpose.
d) “Start date” and “end date” determines the auction duration.
e) “Times Price Changed” gives numerical accounts on how many time has the instant purchase price varied over the course of the auction duration.
f) “Seller's user ID and Feedbacks” allows potential buyers to determine the worthiness of conducting a transaction with the seller.
g) “Ask seller a question button” is a shortcut for buyers to communicate with the seller regarding questions and requests relevant to the item being auctioned prior to making any offers.
h) “Detail description of the item” includes but no limited to both the quantitative and qualitative measurements relevant to the item being auctioned.
i) “Pictures 1 to 6” gives potential buyers any applicable visual illustration of the item being offered.
j) “Shipping and payment details” are the terms set by the seller and automatically accepted by the buyers regarding matters after the auction ends.
k) “End Variable Price” is a function allowing potential buyers to end a variable price auction with an instant purchase at a particular price between the seller's minimum price and desired price.

The process begins when a seller creates an auction listing to sell a particular item by placing item description, item pictures, auction duration, and auction terms over the web page. For example, the seller wishes to sell a designer trench coat using a Variable Price Auction online. The seller will specify detailed description of the trench coat such as its brand name, size measurement, condition, and etc. The seller will post pictures of the item for visual account. The seller will specify the auction duration for 7 days. The seller will also enter a minimum price and a desired price for the item.

Once the auction starts, the system will automatically select an End Variable Price between the seller's minimum price and desired price (including minimum price and desired price) and display the price to all potential buyers. The price can vary at any time as set by the system or set by the seller's preference. The prices can vary in any format between the price range, ascending, declining, and fluctuating as set by the system or set by the seller's preference. If there is no potential buyer willing to accept a particular variable price on the item over the 7 day duration, then the auction will end with no winner. If at any time during the auction duration, a potential buyer is willing to accept a particular variable price at a particular time, the auction will end instantly, with this particular buyer as the winner.

Scenario I

For instance, a seller posted a Variable Price auction to sell a $348 NWT Banana Republic Trench Coat from its Holiday 2005 Collection. The store price is still listed full price for the trench coat. The seller entered a minimum price of $150 and a desired price of $250. The auction will start at 8:00 am (S.E.T) on Aug. 1, 2005 and end on 8:00 am (S.E.T.) on Aug. 8, 2005. The seller can choose for the system to select its variable price and change prices at any time at any price increment or decline. Once the auction starts, the system sets the End Variable Price at $200, which is half-way between the prices set by the seller. Assume there are six potential buyers watching the listing, but no buyer is willing to purchase the coat at $200. Suppose Potential Buyer1 formulates an expected price at $150; Potential Buyer2 formulates an expected price at $210; Potential Buyer3 formulates an expected price at $175; Potential Buyer4 formulates an expected price at $180; Potential Buyer5 formulates an expected price at $200; Potential Buyer6 formulates an expected price at $140.

In the case, Buyer1, Buyer 3, Buyer 4, and Buyer 6 are waiting for the price drop because their expected prices are lower than the End Variable Price at that particular time. Buyer2 and Buyer5 are delaying purchases hoping for a price drop. At 12:00 pm (S.E.T.) on Aug. 2, 2005, End Variable Price was selected at $210. Now, no buyer is willing to accept the price except for Buyer2, who is still waiting for price drop and unwilling to accept the price of $210. At 11:00 am (S.E.T.) on Aug. 3, 2005, End Variable Price was selected at $180. Buyer 2, 4, 5 could accept the price but still waiting for better deal. At 9:00 am (S.E.T.) on Aug. 4, 2005, End Variable Price was selected at $150, now all buyers except Buyer 6 are able to accept the price, but they are still unwilling to and hoping for even lower price, unaware that the lowest price for the item was at $150. At 10:00 pm (S.E.T.) on Aug. 5, 2005, End Variable Price was selected at $178. Buyer 4 who's expected price at $180 accepts the End Variable Price at $178, and ends the auction as the winner. In this scenario, Buyer 1-5 all had a chance to purchase the trench coat at their expected prices, but all were playing waiting game in hoping a much lower price. Buyer 2 and Buyer 5 could have purchase the item at a much lower than their expected prices, but waiting game caused them to make poor choices and ultimately unable to obtain the item. In the end, only Buyer 4 realized the price he/she wanted, and the price is also fair and accepted by the seller.

Scenario II

For instance, a seller posted a Variable Price auction to sell a $1000 NWT French Lalique Crystal Vase. The store price is still listed at full price. The seller entered a minimum price of $600 and a desired price of $800. The auction will start at 8:00 am (S.E.T) on Aug. 11, 2005 and end on 8:00 am (S.E.T.) on Aug. 18, 2005. The seller chooses for the system to change its variable price every 12 hours and at an increment or decline of $20. Once the auction starts, the system sets the End Variable Price at $650. So for every 12 hours, End Variable Price will be increased or decreased by $20 throughout the auction duration or until the auction ends with a winner. Assume there were 8 Potential Buyers; however, none of them formulated an expected price that exceeds the seller's minimum price. So on Aug. 18, 2005 at 8:00 am (S.E.T.), this Variable Price Auction will end with no winner.

Scenario III

Now consider a Scenario similar to Scenario I. A different seller posted a Variable Price auction to sell the exact $348 NWT Banana Republic Trench Coat from its Holiday 2005 Collection as in Scenario I. The store price is still listed full price for the trench coat. The seller entered a minimum price of $170 and a desired price of $210. The auction will start at 11:58 am (S.E.T) on Aug. 21, 2005 and end on 11:58 am (S.E.T.) on Aug. 28, 2005. Assume the seller chooses for the system to select its variable price and change prices at any time at any price increment or decline. Once the auction starts, the system sets the End Variable Price at $200. Assume now there are five potential buyers watching the listing who are all from the listing in Scenario I (excluding Buyer 4). Suppose Potential Buyer1 still holds an expected price at $150; Potential Buyer2 holds an expected price at $210; Potential Buyer3 holds an expected price at $175; Potential Buyer5 holds an expected price at $200; Potential Buyer6 holds an expected price at $140.

In the case, Only Buyer2 and Buyer5's expected prices meet or exceed the End Variable Price. However, both choose to wait for a better price. At 8:00 pm on Aug. 22, 2005, End Variable Price was selected at $170 (seller's minimum price). Buyer2, Buyer3, and Buyer5 could accept the price, but they are still waiting for even better price, unaware of the minimum price of $170 just selected. At 11:00 am on Aug. 24, 2005, End Variable Price was selected at $190. Buyer2 and Buyer5 can accept the price, but are still holding for price to drop. At 11:55 am on Aug. 28, 2005, End Variable Price was selected at $210 again. Unwilling to wait further, Buyer2 accepts the End Variable Price at $210, and ends the auction as the winner. It could also happen that at 11:55 am on Aug. 28, 2005, Buyer 6 revises his/her expected price up to $210 and accepts the End Variable Price and ends the auction as the winner. In both case, the seller successfully sold the item at his/her desired price.

There are more scenarios that can take place under the current invention. The inventors simply describe three of the possible scenarios to effectively demonstrate the invention and the system.

As described above in detail, the present invention provides us with a superior archetype for conducting online auctions for good and services, rights or properties.

In a Variable Price auction, an instant purchase price is not fixed during the course of an auction. Because variable prices will be selected in accordance to a seller's minimum price and desired price, potential buyers are not guaranteed of a lower price through waiting games. Hence, buyers are more likely to accept a changing End Variable Price if that price matches a buyer's price in mind. There will be no need for buyers to delaying purchasing in hoping for a price reduction through re-listing since in a variable price auction, End Variable Price can fluctuate and waiting may not produce a lower price during the auction duration, and will not prevent other potential buyers from purchasing since buyers' prices in mind varies from one to another.

In a Variable Price auction, there is no reserve price for the auction item. Sellers are not the ones who dictate the value of the item; rather, sellers are given the opportunity to enter their price range to prevent losses. Accordingly, potential buyers can formulate their expected prices, and take advantage of fluctuating End Variable Price if a particular price meets their expected prices. It is important to understand that the current invention is not merely a new format for conducting online auctions; rather it is designed to maintain discovery of fair market price through utilizations of buyers' knowledge about an item, while protecting sellers from unfairly lower price caused by buyer's waiting strategies.

Besides the advancements made to the existing auction methods, a Variable Price auction still preserves the beauty of instant liquidity, which is considered significant to many online sellers.

In summary, the present invention has demonstrated its superiorities over other online auction formats in terms of its price discovery mechanism, price protection for sellers, and preservation of liquidity.

It should be understood that while various embodiments of the invention have been described, those skilled in art could make various changes in form, detail, and design without departing from the principle, spirit, and scope of the invention described herein. Applicant's invention is limited only by the scope of the appended claims.

We claim:

1. A method of conducting a sealed offer auction, the method comprising: a) receiving one bid from each bidder; b) the seller will provide both a minimum price to which he/she is willing to sell an item and a desired price that is higher than the minimum price; c) the minimum price and desired price set by the seller are unknown to potential buyers; d) during the auction duration, the price of an item will fluctuate between the minimum price and desired price set by the seller; e) potential buyers have the option to purchase an item at any time during the auction period and end the auction upon his/her purchase; f) the price at which potential buyers is willing to purchase varies from one bidder to another; g) if no buyer is willing to purchase the item at the price range between seller's minimum price and desired price during the auction period, the auction will end with no winner; h) the auction has a scheduled deadline provided by the auction system provider and selected by the seller of the item.

2. A method as in claim 1 wherein said auction is an online auction.

3. A method as in claim 1 wherein said auction is for goods and services.

4. A method as in claim 1 wherein said auction is for rights or properties.

5. “Auction System Provider” in claim 1 is an online auction service provider or an online auction host.

4. An online system for conducting a seal offer auction, the system comprising:
A controller;
Seller's terminal which communicate with said controller whereby seller can enter and transmit, prior to the beginning of an auction, a listing for said at least one item, a listing comprising the headline, the detailed description of the item, pictures associated with the item, shipping and payment terms, and the auction duration;
Web pages which display said auction listing;
A plurality of individual buyer terminals which communicate with said controller whereby said plurality of individual buyers can make a purchase for the auctioning item prior to the auction end;
Said controller displaying the purchase price of an item between its minimum price and the desired price set by the seller;
A winner of said auction listing is one who first accepts a price of an item between seller's minimum price and desired price prior to auction end, and winner's bid ends auction.
A system time tracker which operates on said computer server to track auction duration and time for price to change;
An email system which operates on said computer server to allow communications between said seller and said plurality of individual buyers regarding said auction listing;
A database system which operates on said computer server to store information or data such as user IDs, passwords, email addresses, contact information, credit card numbers, banking account numbers, feedback histories, and all information related to auction listing, processing, and ending results;
A check out system which operates on said computer server to allow said seller enter and calculate total transaction amount and deliver said seller's contact information via email to said winner; and the said check out system is programmed to display said winner's contact information to said seller upon auction closing.

5. The system recited in claim 4 operating in accordance with said specified and limited time period whereby offers for a particular item are only accepted for said specified and limited time period.

6. The system recited in claim 4 wherein said seller terminal is terminal connected to the Internet.

7. The system recited in claim 4 wherein said plurality of individual buyers terminals are terminals connected to the Internet.

8. The system recited in claim 4 wherein said controller comprises a server.

9. The system recited in claim 4 wherein said seller terminal and said plurality of individual potential buyer terminals communicate with said controller via the Internet.
